(19) United States
(12) Patent Application Publication
(10) Pub. No.: US 2023/0110252 A1
(43) Pub. Date: Apr. 13, 2023

(54) HONEYCOMB PLUGGING APPARATUS AND METHODS PROVIDING REDUCED SLUMP

(71) Applicant: CORNING INCORPORATED, Corning, NY (US)

(72) Inventors: Richard Bergman, State College, PA (US); Keith Norman Bubb, Beaver Dams, NY (US); Anthony Joseph Cecce, Elmira, NY (US); Julie Marie Daugherty, Horseheads, NY (US); Patrick David Tepesch, Corning, NY (US)

(21) Appl. No.: 17/960,489

(22) Filed: Oct. 5, 2022

Related U.S. Application Data
(60) Provisional application No. 63/253,170, filed on Oct. 7, 2021.

(51) Int. Cl. B28B 11/00; F01N 3/022; B01D 46/00; B01D 46/24

(52) U.S. Cl. CPC B28B 11/007; F01N 3/0222; B01D 46/0001; B01D 46/244; F01N 2330/34; F01N 2330/06; B01D 2279/30

(57) ABSTRACT

A honeycomb plugging apparatus that reduces slumping of the plugging patty. Honeycomb plugging apparatus includes a plugging head having an open-ended cavity formed from an end wall and a peripheral wall, and a support substructure provided in the open-ended cavity. Methods of plugging and manufacturing honeycomb bodies using the honeycomb plugging apparatus are provided, as are other aspects.

### CROSS-REFERENCE TO RELATED APPLICATION

This application claims the benefit of priority under 35 U.S.C. § 119 of U.S. Provisional Application Ser. No. 63/253,170 filed on Oct. 7, 2021, the content of which is relied upon and incorporated herein by reference in its entirety.

### FIELD

The present disclosure relates to apparatus and methods configured to charge flowable plug-forming material into selected channels of a honeycomb body in order to manufacture plugged honeycomb bodies.

### BACKGROUND

Ceramic honeycomb bodies can have some or all channels plugged with plugs made of a plugging material. Such plugs can be provided in a pattern on one or more ends of the honeycomb body and the plugged honeycomb body can be utilized in a particulate filter to filter particulates, such ash, soot, or other particulate matter in a fluid treatment system, such as an exhaust aftertreatment system.

### SUMMARY

Embodiments of the present disclosure provide a honeycomb plugging apparatus configured to manufacture plugged honeycomb bodies. The honeycomb plugging apparatus comprises a plugging head having an open-ended cavity formed from an end wall and a peripheral wall, and a support substructure provided in the open-ended cavity. The support substructure reduces, minimizes, or even eliminates slump of the next shot of plugging material used to plug a next honeycomb body as the plugged honeycomb body is removed and the next honeycomb body is installed to be plugged.

In embodiments, a sealing surface is disposed radially outwardly from an opened end of the open-ended cavity wherein the sealing surface is configured to seal against an outer edge of a mask of a masked honeycomb structure.

In embodiments, the support substructure comprises horizontal support members extending at least part way across the open-ended cavity.

In embodiments, the support substructure comprises horizontal support members and vertical support members positioned within the open-ended cavity.

In embodiments, the support substructure comprises a grid positioned within the open-ended cavity, wherein the grid comprises horizontal support members intersecting with vertical support members and forming grid pockets configured to support plugging material.

In embodiments, the end wall has flow passages formed there through.

In embodiments, the support substructure comprises planar elements extending toward an open end of the open-ended cavity from the end wall.

In embodiments, the support substructure comprises planar elements that are spaced from and do not contact the end wall of the open-ended cavity.

In embodiments, the support substructure comprises planar elements arranged relative to flow passages formed in an end wall of the open-ended cavity.

In embodiments, the planar elements are aligned between locations of at least some of the flow passages.

In embodiments, the planar elements are aligned in front of at least some of the flow passages.

In embodiments, at least some of the planar elements are aligned between the flow passages and aligned in front of the flow passages.

In embodiments, the support substructure extends at least half of an axial distance between the end wall and an open end of the open-ended cavity.

Embodiments of the present disclosure also provide methods of manufacturing plugged honeycomb bodies wherein at least some channels of a honeycomb body are plugged with plugs. The honeycomb body has a plurality of channels extending between a first end face and an opposing second end face and plugs are formed therein using the method. According to embodiments, the method comprises abutting the honeycomb body with an open-ended cavity containing plugging material to form a chamber between the honeycomb body and the open-ended cavity, wherein the open-ended cavity contains a support substructure, and the honeycomb body comprises a mask with openings provided on an end face thereof that provide communication into a subset of the channels of the honeycomb body; flowing plugging material from the chamber through the openings into the subset of the channels to form plugs in the honeycomb body and arranging the honeycomb body as a plugged honeycomb body; and separating the plugged honeycomb body from the open-ended cavity, wherein the support substructure supports remaining plugging material contained in the open-ended cavity after the separating and prevents slumping of remaining plugging material in the open-ended cavity.

In embodiments, the flowing of the plugging material from the chamber through the openings to form plugs in the honeycomb body further comprises flowing plugging material from a reservoir through flow passages formed in an end wall of the open-ended cavity.

In embodiments, the flow passages are unblocked by motion of a flow control member prior to the flowing of the plugging material from the reservoir.

In embodiments, the flowing of the plugging material through flow passages further comprises flowing the plugging material through grid pockets formed by the support substructure.

In embodiments, the plugging material flowing through an individual one of the flow passages flows through multiple support cells formed by the support substructure.

In embodiments, the plugging material flowing through multiple adjacent ones of the flow passages flows through a common support cell formed by the support substructure.

Embodiments of the present disclosure also provide methods of manufacturing plugged honeycomb bodies wherein at least some channels of a honeycomb body are plugged with plugs. The honeycomb body has a plurality of channels extending between a first end face and an opposing second end face and plugs are formed therein using the method. According to embodiments, the method comprises abutting a honeycomb body comprising a mask on an end face thereof with a volume of plugging material contained in an open-ended cavity to form a chamber between the honeycomb body and the open-ended cavity, the open-ended cavity comprising a support substructure therein; flowing plugging material from the chamber into the honeycomb body through openings in the mask to arrange the honeycomb body as a plugged honeycomb body; separating the plugged honeycomb body from the open-ended cavity; and priming the chamber with plugging material for a subsequent plugging process, wherein slumping of the plugging material remaining in the open-ended cavity for the subsequent plugging process is reduced by the support substructure supporting the plugging material.

In embodiments, the priming occurs as part of the step of flowing plugging material from the chamber into the honeycomb body.

Embodiments of the present disclosure also provide a method of manufacturing a honeycomb body comprising any of the methods of plugging disclosed herein.

Additional features of the disclosure will be set forth in the description which follows, and will be apparent from the description, or may be learned by practice of the disclosure. It is to be understood that both the foregoing general description and the following detailed description are provide example embodiments and is intended to provide further explanation of the disclosure.

### BRIEF DESCRIPTION OF THE DRAWINGS

The accompanying drawings, which are included to provide a further understanding of the disclosure, are incorporated in and constitute a part of this specification, illustrate example embodiments of the disclosure, and together with the description, serve to explain the principles of the disclosure.

FIG. 1 schematically illustrates a perspective view of an example embodiment of a honeycomb body, which is configured to be plugged using plugging methods and honeycomb plugging apparatus of the present disclosure.

FIG. 2 schematically illustrates an end view of an end face of a honeycomb body comprising a honeycomb structure made up of walls and channels wherein some of the channels are to be plugged using the plugging methods and honeycomb plugging apparatus of the present disclosure.

FIG. 3 schematically illustrates a perspective view of a honeycomb body comprising a mask (shown sectioned with only half shown) provided at an end face thereof according to embodiments of the present disclosure.

FIG. 4 schematically illustrates an end view of an end face of a plugged honeycomb body wherein at least some of the channels have been plugged with plugs using plugging methods and honeycomb plugging apparatus of the present disclosure.

FIG. 5 schematically illustrates a partially cross-sectioned side view of a honeycomb plugging apparatus configured to form plugs in a masked honeycomb body according to embodiments disclosed herein.

FIG. 6 schematically illustrates an enlarged, cross-sectioned, partial side view of a honeycomb plugging apparatus illustrating the support substructure disposed within a chamber formed from closure of an open-ended cavity and an abutting masked honeycomb body and forming plugs therewith according to embodiments of the disclosure.

FIG. 7A schematically illustrates a front plan view of a front face of a plugging head illustrating an example configuration of a support substructure having a one-to-one ratio of flow passage to grid pocket according to embodiments disclosed herein.

FIGS. 7B-7D schematically illustrate partial views of the axial alignment of the support substructure with flow passages formed in an end wall of the open-ended cavity according to various embodiments disclosed herein.

FIG. 7E schematically illustrates an enlarged, cross-sectioned, partial side view of a honeycomb plugging apparatus illustrating an embodiment of support substructure disposed within a chamber formed from closure of an open-ended cavity and an abutting masked honeycomb body having configuration with a four-to-one ratio of flow passages to grid pocket according to embodiments of the disclosure.

FIG. 8A schematically illustrates a front view of an alternative support substructure with a four-to-one ratio of flow passages to grid pocket according to embodiments disclosed herein.

FIG. 8B schematically illustrates a front view of an alternative support substructure with suspended grid pockets with the support substructure spaced from the end wall of the open-ended chamber according to embodiments disclosed herein.

FIG. 9 illustrates a flowchart describing a method of plugging a honeycomb body according to embodiments disclosed herein.

### DETAILED DESCRIPTION

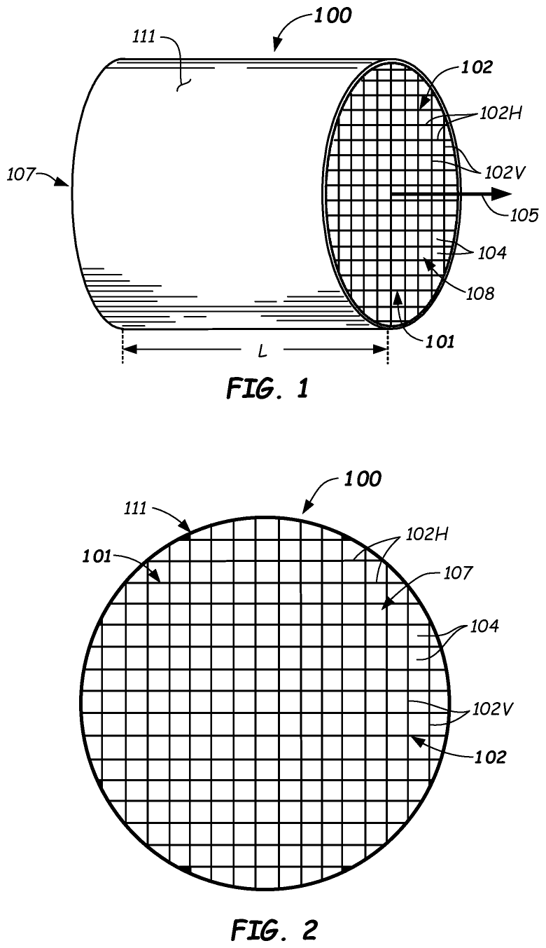

Particulate filters can comprise plugged honeycomb bodies that are received in a canning structure or other housing. The filters can be coupled within a pollution abatement system, such as in an engine exhaust system. An example particulate filter is formed using a honeycomb body 100 as is shown in FIGS. 1 and 2 comprising honeycomb structure 101 comprising an arrangement of interconnected porous walls 102. In the depicted embodiment, the interconnected porous walls 102 are made up of vertical walls 102V and horizontal walls 102H intersecting and forming a series of channels 104 that extend in parallel to one another in an axial direction 105 along the length L from an inlet end face 107 to and outlet end face 108.

In the depicted embodiment, the channels 104 have a rectangular (e.g., square) cross-sectional shape. However, the walls 102 can have other orientations and can form channels 104 that have cell shapes that are rectangular non-square, quadrilateral, circular, triangular, pentagonal, hexagonal, heptagonal, octagonal, trapezoidal, diamond (rhombus), polygonal, wedge, pie, radial, or other closed geometric shapes, and combinations thereof. For example, combinations can include such cell shape combinations as “octa-square” (combinations of octagonal and square cell shapes), “hexa-diamond” (combinations of hexagonal and diamond cell shapes), “recta-square” (combinations of squares and rectangular non-squares), and the like. In embodiments, some of the channels can have a larger cross-sectional area than others. For example, some cells can have relatively smaller cross-sectional area square cell shapes and others can have relatively larger cross-sectional area square cell shapes or relatively larger cross-sectional area octagonal shapes.

The porous walls 102 can have any suitable thickness in the transverse direction (across the wall 102), such as from 0.004 inch to 0.020 inch, for example. Other wall thicknesses could be used. The honeycomb body 100 can comprise a skin 111 formed as a peripheral layer, which can be somewhat thicker than the wall thickness (e.g., 3X or more), for example. Other skin thicknesses could be used. The honeycomb body 100 can have a cell density of from about 50 to about 600 cells per square inch (cpsi), for example, however other cell densities can be used.

The honeycomb body 100 comprising the honeycomb structure 101 can be formed using conventional methods from a batch mixture containing inorganic and organic materials. For example, a suitable batch mixture can comprise ceramic particles or ceramic precursor particles, or both, an organic binder, a liquid vehicle (e.g., water), and an optional rheology modifier, an optional pore former, and/or one or more optional processing additives. The batch mixture can be extruded through an extrusion die coupled to an extruder to form a green honeycomb body, as is conventional. The extrusion can be performed using any conventional extruder or method. Other suitable methods could be used to form the green honeycomb body.

When fired, the green honeycomb body is transformed (sintered) into a porous honeycomb body 100. The porous honeycomb body 100 can comprise interconnected porosity and may be suitable for high temperatures encountered when used in exhaust gas treatment systems. The porous ceramic material of the porous honeycomb body 100 can comprise cordierite, aluminum titanate, alumina, mullite, silicon carbide, silicon nitride, and the like, or combinations thereof. Other suitable ceramics, glass-ceramics, glass, or combinations thereof can be used.

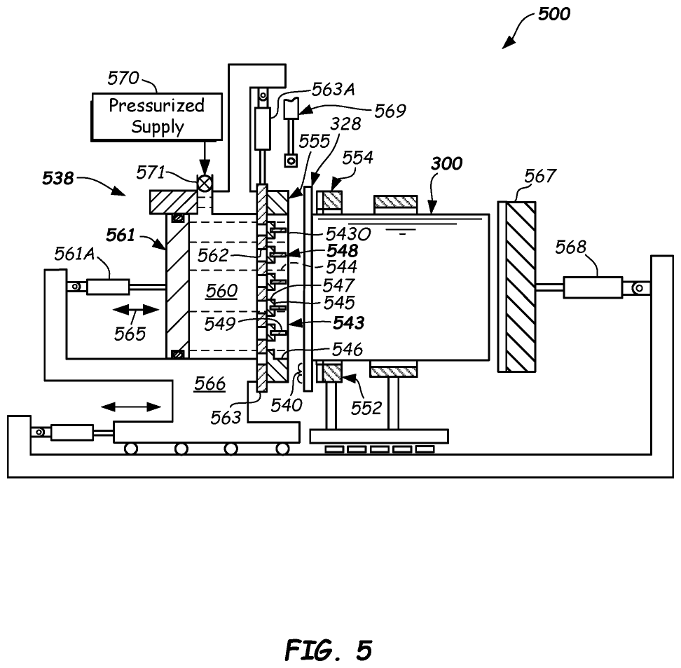

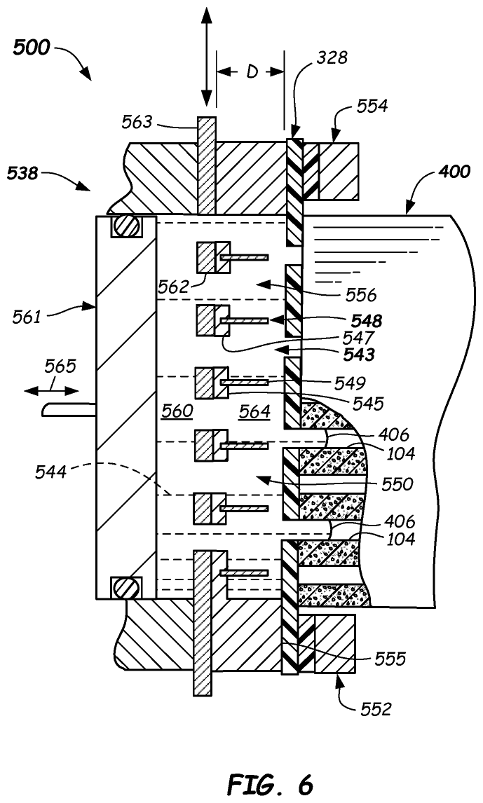

After firing to attain the porous honeycomb body 100 having the desired porosity and microstructure, plugging (formation of plugs) of channels 104 of one or more end faces 107, 108 of the honeycomb body 100 can be accomplished by the use of the plugging apparatus 500 and components thereof shown and described with reference to FIG. 5 through FIG. 8B to form a plugged honeycomb body 400 as is shown in FIG. 4 and FIG. 6. The channels 104 in the honeycomb body 100 can be plugged with plugs 406 in any desired pattern, such as the checkerboard pattern shown in FIG. 4 or any other suitable pattern. In embodiments, a partial filter can be formed by plugging less than all of the channels 104. The plugging apparatus 500 is operable to produce plugs 406 in the end of the honeycomb body 100 and form the plugged honeycomb body 400 by plugging certain channels 104 at one or both of the ends 107, 108 of the honeycomb body 100 in any desired pattern.

As is shown in FIG. 4, the plugged honeycomb body 400 comprises every other channel 104 plugged with a plug 406 on the inlet end face 107. The channels 104 that are unplugged at the inlet face 107 are referred to as “inlet channels.” The inlet channels that are not plugged at the inlet end can be plugged with plugs (like plugs 406) at the outlet end 108 in this embodiment. The outlet channels are plugged with plugs 406 at the inlet end 107 (as shown), but can be unplugged at the outlet end to form “outlet channels.” Thus in operation, with this configuration, fluid flow (e.g., exhaust gas flow) is forced through the porous walls 102 and particulates may be trapped/filtered from the fluid flow in and on the porous walls 102. However, in some embodiments, some channels 104 that are unplugged at the inlet end face 107 can also be unplugged at the outlet end face 108 and thus may flow through channels embodying a partial filter made up of some plugged inlet channels and some flow through channels. The present honeycomb plugging apparatus 500 and method 900 is useful for plugging conventional and partial filters having any desired plugging pattern of plugs formed therein.

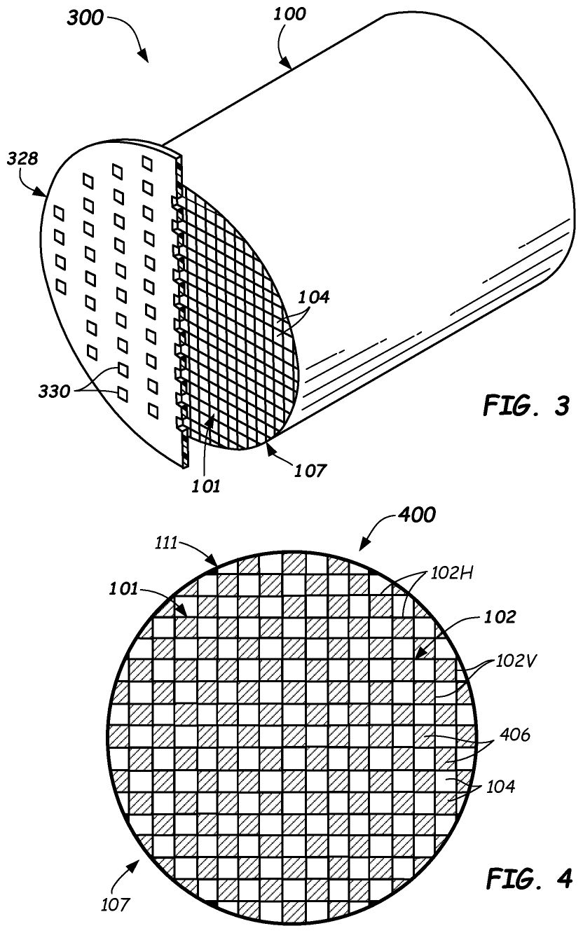

With reference to FIGS. 3, 4, 5, 6, and 9, plugging apparatus 500 and plugging methods 900 that are configured to form plugs 406 in a honeycomb body 100 having a honeycomb structure 101 are described. The plugging apparatus 500 is useful for fast plugging to form plugs (like plugs 406) in such honeycomb bodies 100. As shown in FIG. 3, the methods of plugging described herein involve providing the honeycomb body 100 with a mask 328 on an end face (e.g., end face 107) thereof. The honeycomb body 100 with a mask 328 thereon is referred to as a “masked honeycomb body 300” herein. For example, the mask 328 can be adhered to an inlet end face 107 thereof. Mask 328 can be a transparent or translucent sheet of material that can comprise a suitable adhesive that aids in adhering the mask 328 to ends of walls 104 of the inlet end face 107. The honeycomb body 100 could also have a mask (not shown) coupled to an outlet end face 108 opposite the inlet end face 107. The ends can be sequentially plugged by plugging a first end, rotating the honeycomb body, and then plugging a second opposite end using the plugging apparatus 500.

The mask 328 (only half shown) can comprise holes 430 precisely positioned therein. Holes 430 can be formed so that they are aligned with respective channels 104 desired to be plugged. In embodiments, the mask 328 is a thin polymer film that is transparent or translucent and the holes 430 can be formed/cut with a laser or other suitable method after imaging the exact locations of the channels 104 to be plugged through the mask 328. Other suitable methods for forming the mask can be used. In embodiments, such as where the cell density is relatively low, the mask 328 can comprise locator members (e.g., nubs) that locate in the some of the channels 104 not being plugged and position the mask 428 relative to the end face (e.g., inlet end face 107).

As is shown in FIGS. 5 and 6, the plugging apparatus 500 comprises a plugging head 538 comprising an open-ended cavity 543 containing a volume of plugging material 544 therein, and a first clamping portion 552 and a second clamping portion 554. Both clamping portions 552, 554 cooperate to releasably clamp an edge (e.g., outer peripheral portion 540) of the mask 328 of the masked honeycomb structure 400 against a sealing surface 555 disposed radially outwardly from an open end 5430 (FIG. 5) of the open-ended cavity 543. Other methods of sealing around the mask periphery could be used.

The open-ended cavity 543 is formed from an end wall 545 and a peripheral wall 546. The end wall 545 can be planar and can comprise a plurality of flow passages 547 formed there through. Flow passages 547 can be arranged in rows as shown in FIG. 6. However, other arrangements are possible, such as arrangements of flow passages arranged in nested concentric circles of increasing radius. The peripheral wall 546 can be oriented perpendicular to the end wall 545 and can have the approximate shape of the outer periphery of the honeycomb body 100 to be plugged. Other configurations, such as a tapered wall can be used. The term “open-ended” as used herein refers to the configuration of the plugging head 538 having an open end 5430 that is subsequently closed to form a chamber 564 when the mask 328 and masked honeycomb 300 are moved to abut and close the open-ended chamber 534.

The outer peripheral portion 540 of the mask 528 can extend radially outward, such as from an outer surface 111 (e.g., skin) of the honeycomb body 100. In embodiments, the mask 528 extends past the outer surface 111 of the skin 110, such as about 1 inch (2.54 cm) past, but it could extend to any distance sufficient to allow secure sealing, such as by clamping of the outer portion 540 between the clamping portions 552, 554 and the sealing surface 555 as shown in FIG. 6.

Within the plugging apparatus 500, the volume of plugging material 544 is contained in the open-ended cavity 543. The open-ended cavity 543 can have a shape that can generally approximate the shape of the end face (e.g., inlet end face 107 or outlet end face) of the honeycomb body 100 being plugged. For example, the shape can be round if the outer perimeter shape of the honeycomb body 100 is round or another shape if the outer perimeter shape is another shape. At least a portion of the plugging material 544 is transferred through operation of the honeycomb plugging apparatus 500 to form the plugs 406 in the honeycomb body 100 (See FIG. 6).

In the embodiment shown, the open-ended chamber 543 is sized to hold a patty of the plugging material 544. The patty of plugging material 544 in the open-ended chamber 543 can be substantially uniform in thickness to reduce the effects of compressibility of the plugging material 544. This aids in forming plugs 406 of uniform depth within the masked honeycomb body 300.

In embodiments, the open-ended chamber 543 has a depth D. For example, the depth D can be on the order of approximately ½ inch (1.27 cm). Alternatively, the open-ended chamber 543 can have any depth that is large enough to ensure sufficient plugging material 544 flow such that the entire cross-sectional area of the open-ended chamber 543 is filled.

In order to substantially reduce, minimize, or substantially eliminate slumping of the plugging material 544 in the open-ended cavity 543 after separation of a plugged honeycomb body 400 from the plugging head 538 (as shown in FIG. 5), a support substructure 548 is provided in the open-ended cavity 543. Slumping occurs due to the liquid slurry nature of the plugging material 544. When the plugged honeycomb body 400 is separated from the plugging head 538, the open-ended cavity 543 can already be primed with plugging material for a subsequent plugging process, i.e., plugging of a subsequent honeycomb body. For example, the plugging material primed for the subsequent plugging process can already be in the open-ended chamber 543 as a result of plugging the honeycomb body 400. When the plugging apparatus 500 is opened while removing the plugged honeycomb body 400 from the plugging head 538 and loading a new masked honeycomb body 300 to the plugging head 538, the support substructure 548 supports the plugging material 544 in the open-ended chamber 543. The support substructure 548 has a configuration that supports the plugging material 544 across the open-ended chamber 543 so slumping is substantially reduced, minimized, or eliminated. In embodiments, slumping of the plugging material 544 after separation does not exceed more than 5 mm out of the plugging head 538 past the sealing surface, measured axially.

The support substructure 548 can have any suitable structure for supporting and holding the plugging material 544 upon separation of the plugged honeycomb body 400. Nonetheless, it should be apparent that the mask 328 of the next masked honeycomb body 400 to be plugged should be quickly sealed between clamping members 552, 554 and the sealing surface 555 after removing the prior plugged honeycomb body 400 that was plugged according to the plugging method 900.

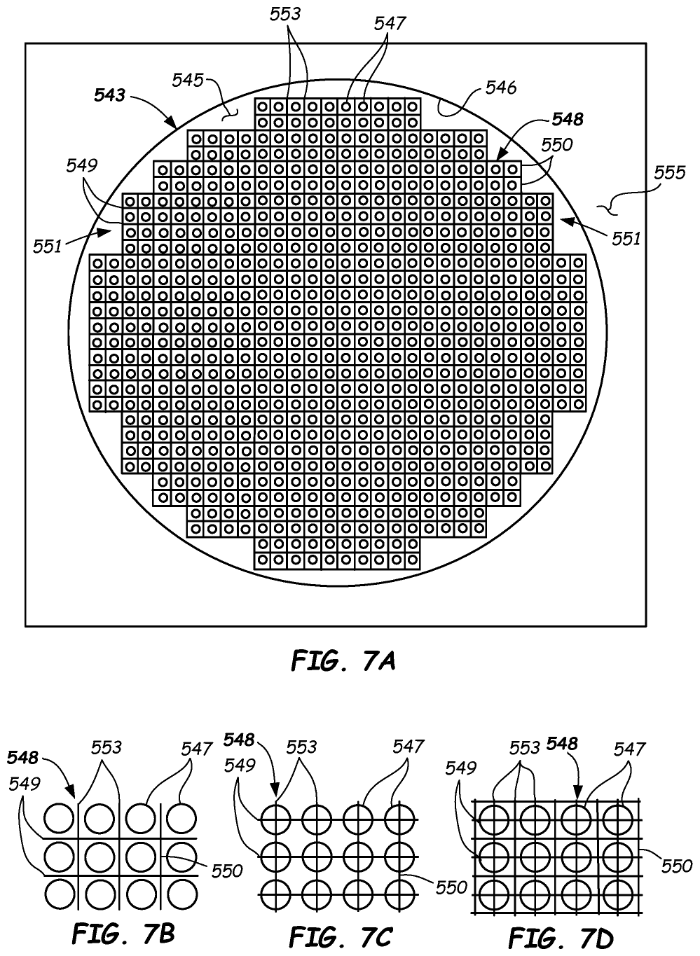

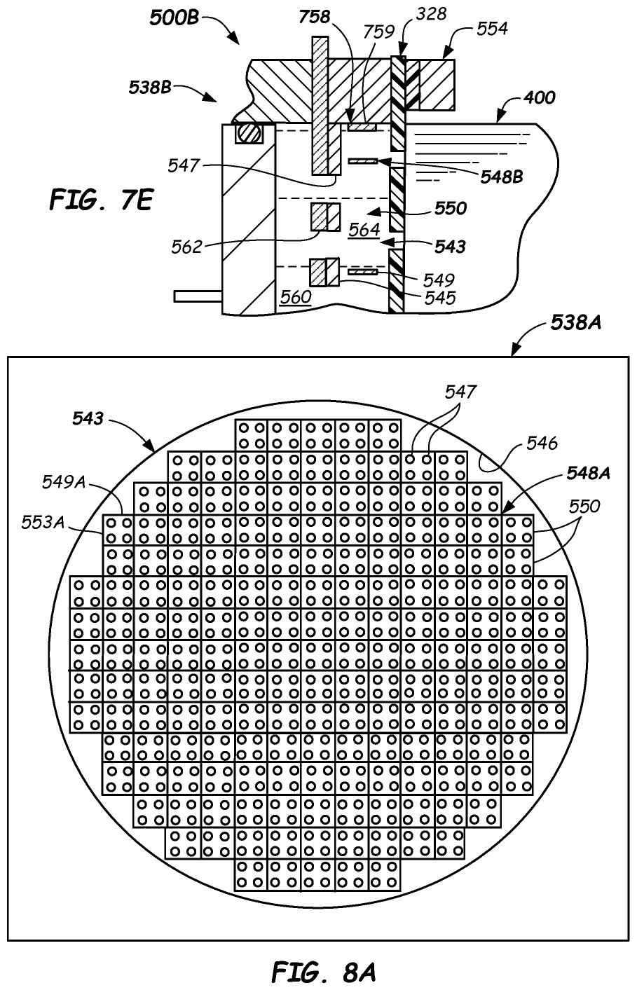

FIG. 6 and FIG. 7A illustrate one configuration a structure of the support substructure 548 comprising at least horizontal support members 549 (a few labeled) extending at least part way across the open-ended cavity. In the depicted embodiment, the horizontal support members 549 can extend greater than 80%, or even 90% across the width of the open-ended chamber 543 at that horizontal location. In embodiments, the support substructure 548 extends through at least half of an axial distance D (see FIG. 6) between the end wall 545 and the open end 5430 of the open-ended cavity 543.

As best shown in FIG. 7A, the horizontal support members 549 can have a gap 551 between their respective ends and the peripheral wall 546. In embodiments, the support substructure 548 can comprise a grid of horizontal support members 549 and vertical support members 553 positioned within the open-ended cavity 543, although embodiments can comprise only horizontal members 549 making up the support substructure 548. The support substructure 548 can comprise planar elements arranged parallel relative to a direction of flow through flow passages 547 formed in the end wall 545 of the open-ended cavity 543. In particular, the grid can comprise horizontal support members 549 intersecting with vertical support members 553 and forming grid pockets 550 configured to support the plugging material 544 therein. In this depicted embodiment a single one of the flow passages 547 is included and aligned with each grid pocket 550 and each grid pocket 550 is configured to support the plugging material 544 therein. In this embodiment, the grid spacing comprises a ratio of one flow passage 547 to each grid pocket 550, i.e., a one-to-one ratio of flow passage 547 to grid pocket 550.

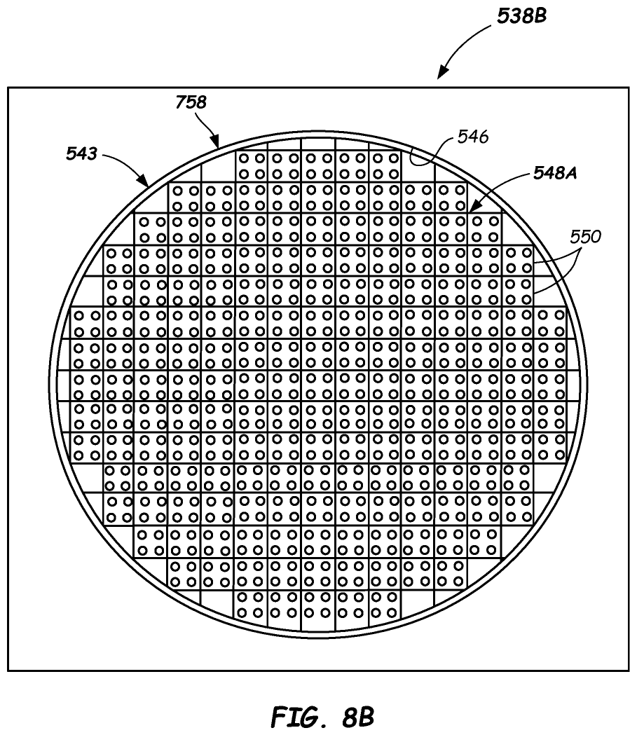

Other grid spacings are possible including more than one flow passage 547 aligned with each grid pocket 550. For example, FIG. 8A illustrates a plugging head 538A comprising a support substructure 548A in the open-ended cavity 543 that comprises a grid of horizontal support members 549A and vertical support members 553A. In this embodiment, the grid spacing comprises a ratio of four flow passages 547 to each grid pocket 550, i.e., a four-to-one ratio of flow passages 547 to grid pocket 550.

Honeycomb plugging apparatus 500 comprising the support substructure 548 can comprises planar elements, as shown in FIG. 6 and FIG. 7A, extending toward the open end 5430 of the open-ended cavity 543 from the end wall 545. Support substructure 548 comprising planar elements can be attached to the end wall 545, by any suitable means, such as by being received and secured in slots formed in the end wall 545, for example. Cuts at the intersections of the support members 549 and vertical support members 553 can be made half way through the respective support members 549 to allow the dovetailing of the supports as a grid. Both horizontal support members 549 and vertical support members 553 can be planar and extend (e.g., at least part way) from the end wall 545 towards the open end 5430 of the open-ended cavity 543.

FIGS. 7E and 8B schematically illustrate a cross-sectioned partial view and a front view, respectively, of another alternative design of plugging head 538B of a plugging apparatus 500B. Those features not described for plugging head 538B are the same as in plugging head 538 of FIGS. 5 and 6. In this embodiment, the support substructure 548B can also comprise planar elements forming a grid, but in this embodiment, the planar elements are spaced from, and do not contact, the end wall 545 of the open-ended cavity 543, i.e., they are suspended in the open-ended cavity 543. Such planar elements forming the grid can be provided as part of an insert element 758 provided in contact with the peripheral wall 546 so that the grid is suspended within the open-ended cavity 543.

The planar elements of the suspended grid can be coupled to a peripheral support member 759 coupled to the peripheral wall 546 by any suitable means such as welding or press fit. In this depicted embodiment, four flow passages 547 are included and aligned with at least some of the grid pockets 550, wherein the grid pockets 550 are configured to support the plugging material 544, and the ratio of flow passages 547 to grid pockets 550 is four-to-one.

Various other arrangements of the grid pockets are possible, as is shown in partial views of FIGS. 7B through 7D. In embodiments, planar elements (e.g., horizontal support members 549 and/or vertical support members 553) can be aligned between locations of at least some of the flow passages 547 as is shown in FIG. 7B. Optionally, the planar elements (e.g., horizontal support members 549 and/or vertical support members 553) can be aligned in front of at least some of the flow passages 547, such as aligned with a centerline of the flow passages 547 as shown in FIG. 7C. In embodiments, at least some of the planar elements (e.g., horizontal support members 549 and vertical support members 553) are aligned between the flow passages 547 and some aligned in front of the flow passages 547, as shown in FIG. 7D. Other ratios of flow passages to grid pockets can be used. Other arrangements of flow passages 547 can be used, such as arrangements in concentric circles. Other grid configurations can be used, such as concentric circles. Flow passages 547 can be arranged in concentric circles and can be aligned to the concentric grid configurations.

Referring to FIGS. 5 and 6 in more detail, the plugging head 538 can contain a reservoir 560 that is fluidly connected at times to the open-ended chamber 534 and also contains plugging material 544 therein. In operation, motion of a piston 561 via action of piston actuator 561A causes the material 544 in reservoir 560 to pass through the flow passages 547 in end wall 545 through passages 562 in a flow control member 563 (when opened). Flow control member 563 can comprise a slide with the same hole pattern as the hole pattern of flow passages 547 through end wall 545. Actuation of control actuator 563A moves control member 563 to substantially align control passages 562 and flow passages 547.

The movement of the piston 561 transfers the plugging material 544 from the reservoir 560 to the open-ended chamber 563. The plugging material 544 forced into the chamber 564 formed from the closing of the open-ended chamber 543 with the mask 328 concomitantly forces approximately the same amount of the plugging material 544 out of the chamber 564. This fills/charges the selected channels 104 of the masked honeycomb body 300 mounted to the plugging head 538 and form plugs 406 to a desired plug depth. The piston 561 moves in the direction of arrow 565 (extending for plugging and retracting for refilling with plugging material 544), for example, by piston actuator 561A mounted between the piston 561 and a moveable frame 566.

The flow of plugging material 544 between the reservoir 560 and the chamber 564 is controlled by opening (aligning) and closing (misaligning) the passages 562 of the flow control member 563 (FIGS. 5 and 6) and flow passages 547. In embodiments, the flow control member 563 comprises a moveable member such as a moveable shutter plate that is moveable relative to a stationary member comprising the end wall 545. To stop flow, the flow control member 563 is moved to a first position as shown in FIG. 5. In this position, the masked honeycomb body 300 can be moved by actuation of pusher 567 via actuator 568 to bring the mask 328 into contact with sealing surface 555 of the plugging head 538 and move clamps 552, 554 against outer portion 540 of mask 328. To allow flow, flow control member 563 is moved to a second position as shown in FIG. 6. In this condition, the passages 562 are substantially aligned with the like flow apertures 547 formed in the end wall 545 of the open-ended chamber 543 and flow can be initiated.

The passages 547, 562 can be of any size, shape, or spatial proximity to allow flow of the plugging material 544 there through, yet still allow sufficient shut off of flow of the plugging material 544 when misaligned. In embodiments, the passages 547, 562 cover approximately 25 percent of the possible surface area of the control member 563 and end wall 545, respectively. In embodiments, the passages of the control member 563 are substantially similar to the apertures 547 in the end wall 545, to allow smooth transition of the plugging material 544 from the reservoir 560 to the chamber 564 and allow precise flow control thereof. After the aligning of the passages 547, 562 and transfer of the plugging material 544, the passages 547, 562 can be misaligned and the reservoir 560 can be refilled with plugging material 544, such as from pressurized supply 570 via opening valve 571.

According to the plugging method, the flow control member 563 is moved to the opened position and then the piston 561 moves towards the masked honeycomb body 300. Once the piston 561 has begun forcing plugging material 544 into the masked honeycomb body 300, the piston 561 preferably does not stop until the plugs 406 have reached the desired depth. This aids in forming plugs 406 of uniform depth.

Once the desired depth is achieved, the piston 561 stops and is retracted slightly to allow the pressure built up by the plugging process to be relieved. At this point the pressure has been relieved and the flow control member 563 is actuated to close (misalign) the passages 547, 562 between the reservoir 560 and the chamber 564. Once closed, the plugged honeycomb body 400 can be removed from the open-ended chamber 543 by first separating and then cutting adjacent the open-ended chamber 543 with a cutting implement 569, which can comprise a wire spanning horizontally across the sealing surface 555 and which is moveable vertically. Other suitable cutting implements can be used to provide a planar surface of the patty of the plugging material 544 in the open-ended cavity 543 upon separation.

Because of the improved slump control provided by the support substructure 548, viscosity of the plugging material 544 can be decreased slightly to provide better control of plug depth. Other features and operation of the plugging apparatus 500 not described herein are described in U.S. Pat. Nos. 7,922,951 and 8,609,002, which are hereby incorporated by reference herein.

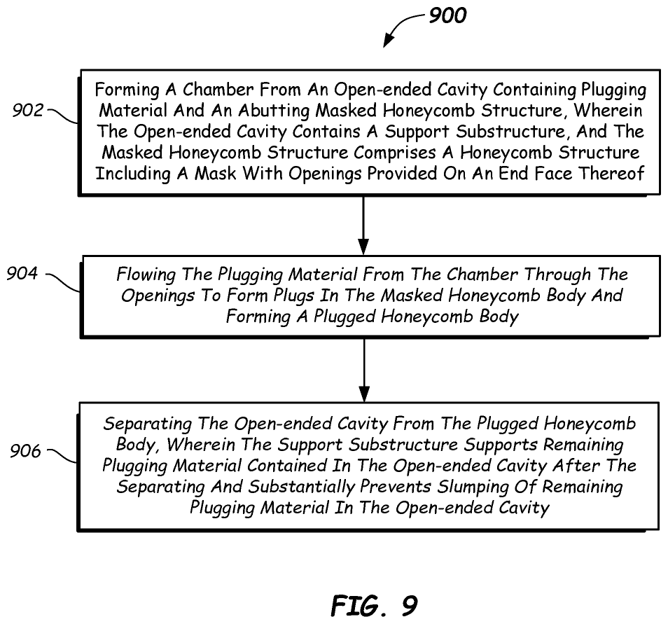

In embodiments, a method 900 of plugging channels (e.g., channels 104) of a honeycomb body (e.g., honeycomb body 100) is provided as shown and described with reference to the flowchart of FIG. 9. The method 900 comprises, in block 902, forming a chamber (e.g., chamber 564) from an open-ended cavity (e.g., open-ended cavity 543) containing plugging material (e.g., plugging material 544) and an abutting masked honeycomb body (e.g., masked honeycomb body 300), wherein the open-ended cavity contains a support substructure (e.g., support substructure 548, 548A, 548B), and the masked honeycomb body comprises a honeycomb body (e.g., honeycomb body 100) comprising a mask (e.g., mask 328) with openings (e.g., openings 340) provided on an end face (e.g., end face 107 or end face 108) thereof.

The method 900 further comprises, in block 904, flowing the plugging material (e.g., plugging material 544) from the chamber (e.g., chamber 564) through the openings (e.g., openings 340) to form plugs (e.g., plugs 406) in the masked honeycomb body (e.g., masked honeycomb body 400) and forming a plugged honeycomb body (e.g., plugged honeycomb body 400).

The method 900 further comprises, in block 906, separating the open-ended cavity (e.g., open-ended cavity 543) from the plugged honeycomb body (e.g., plugged honeycomb body 400), wherein the support substructure (e.g., support substructure 548, 548A, 548B) supports remaining plugging material (e.g., plugging material 544) contained in the open-ended cavity (e.g., open-ended cavity 543) after the separating and substantially prevents slumping of the plugging material (e.g., plugging material 544) remaining in the open-ended cavity (e.g., open-ended cavity 543).

In more detail, the method 900 comprising flowing of the plugging material 544 from the chamber 564 through the openings 340 to form plugs 406 in the masked honeycomb body 300 can further comprise flowing plugging material 544 from a reservoir 560 through flow passages 547 formed in an end wall 545 of the open-ended cavity 543. In particular, the flow passages 547 are unblocked through motion of a flow control member 563 prior to the flowing of the plugging material 544 from the reservoir 560. Further, the flowing of the plugging material 544 through flow passages 547 further comprises flowing the plugging material 544 through grid pockets 550 formed by the support substructure 548, 548A, 548B wherein embodiments of such grid pockets 550 are shown in FIGS. 7A-7E, for example. The ratio of flow passages 547 to grid pockets 550 can be from 1:1 to 4:1, for example.

As can be seen in FIG. 7C and FIG. 7D, the plugging material 544 flowing through an individual one of the flow passages 547 can flow through multiple grid pockets 550, such as though adjacent grid pockets 550 formed within the support substructure 548. In embodiments, such as shown in FIGS. 7E and 8B, the plugging material 544 that is flowing through multiple adjacent ones of the flow passages 547 can flow through a common grid pocket 550 formed by the support substructure 548A, 548B, such as when the ratio of flow passages 547 to grid pockets 550 is greater than 1:1, such as from 1:1 to 4:1.

It will be apparent to those skilled in the art that various modifications and variations can be made in the present disclosure without departing from the scope of the disclosure. Thus, it is intended that the claims cover the modifications and variations of this disclosure provided they come within the scope of the claims and their equivalents.

What is claimed is:

1. A honeycomb plugging apparatus, comprising:
a plugging head having an open-ended cavity formed from an end wall and a peripheral wall; and
a support substructure provided in the open-ended cavity.

2. The honeycomb plugging apparatus of claim 1, comprising a sealing surface disposed radially outwardly from an opened end of the open-ended cavity wherein the sealing surface is configured to seal against an outer edge of a mask of a masked honeycomb structure.

3. The honeycomb plugging apparatus of claim 1, wherein the support substructure comprises horizontal support members extending at least part way across the open-ended cavity.

4. The honeycomb plugging apparatus of claim 1, wherein the support substructure comprises horizontal support members and vertical support members positioned within the open-ended cavity.

5. The honeycomb plugging apparatus of claim 1, wherein the support substructure comprises a grid positioned within the open-ended cavity, wherein the grid comprises horizontal support members intersecting with vertical support members and forming grid pockets configured to support plugging material.

6. The honeycomb plugging apparatus of claim 1, wherein the end wall has flow passages formed there through.

7. The honeycomb plugging apparatus of claim 6, wherein the support substructure comprises planar elements extending toward an open end of the open-ended cavity from the end wall.

8. The honeycomb plugging apparatus of claim 6, wherein the support substructure comprises planar elements that are spaced from and do not contact the end wall of the open-ended cavity.

9. The honeycomb plugging apparatus of claim 1, wherein the support substructure comprises planar elements arranged relative to flow passages formed in an end wall of the open-ended cavity.

10. The honeycomb plugging apparatus of claim 9, wherein the planar elements are aligned between locations of at least some of the flow passages.

11. The honeycomb plugging apparatus of claim 9, wherein the planar elements are aligned in front of at least some of the flow passages.

12. The honeycomb plugging apparatus of claim 9, wherein at least some of the planar elements are aligned between the flow passages and aligned in front of the flow passages.

13. The honeycomb plugging apparatus of claim 1, wherein the support substructure extends at least half of an axial distance between the end wall and an open end of the open-ended cavity.

14. A method of plugging channels of a honeycomb body, comprising:
abutting the honeycomb body with an open-ended cavity containing plugging material to form a chamber between the honeycomb body and the open-ended cavity, wherein the open-ended cavity contains a support substructure, and the honeycomb body comprises a mask with openings provided on an end face thereof that provide communication into a subset of the channels of the honeycomb body;
flowing plugging material from the chamber through the openings into the subset of the channels to form plugs in the honeycomb body and arranging the honeycomb body as a plugged honeycomb body; and
separating the plugged honeycomb body from the open-ended cavity, wherein the support substructure supports remaining plugging material contained in the open-ended cavity after the separating and prevents slumping of remaining plugging material in the open-ended cavity.

15. The method of claim 14, wherein the flowing of the plugging material from the chamber through the openings to form plugs in the honeycomb body further comprises flowing plugging material from a reservoir through flow passages formed in an end wall of the open-ended cavity.

16. The method of claim 15, wherein the flow passages are unblocked by motion of a flow control member prior to the flowing of the plugging material from the reservoir.

17. The method of claim 15, wherein the flowing of the plugging material through flow passages further comprises flowing the plugging material through grid pockets formed by the support substructure.

18. The method of claim 17, wherein the plugging material flowing through an individual one of the flow passages flows through multiple support cells formed by the support substructure.

19. The method of claim 17, wherein the plugging material flowing through multiple adjacent ones of the flow passages flows through a common support cell formed by the support substructure.

20. A method of plugging a honeycomb body, comprising:
abutting a honeycomb body comprising a mask on an end face thereof with a volume of plugging material contained in an open-ended cavity to form a chamber between the honeycomb body and the open-ended cavity, the open-ended cavity comprising a support substructure therein;
flowing plugging material from the chamber into the honeycomb body through openings in the mask to arrange the honeycomb body as a plugged honeycomb body;
separating the plugged honeycomb body from the open-ended cavity; and
priming the chamber with plugging material for a subsequent plugging process,
wherein slumping of the plugging material remaining in the open-ended cavity for the subsequent plugging process is reduced by the support substructure supporting the plugging material.
